(19) United States
(12) Patent Application Publication
(10) Pub. No.: US 2005/0202132 A1
(43) Pub. Date: Sep. 15, 2005

(54) Edible fat-based shell for confectioneries and method for producing same

(76) Inventors: Dennis Scott Wolever, Marysville, OH (US); Michael Lee Talbot, Dublin, OH (US)

Correspondence Address: WINSTON & STRAWN LLP, 1700 K STREET, N.W., WASHINGTON, DC, 20006, US

(21) Appl. No.: 10/800,222

(22) Filed: Mar. 12, 2004

(51) Int. Cl. A21D 13/00

(52) U.S. Cl. 426/138

(57) ABSTRACT

The present invention relates to an edible fat-based shell upon a packaging support having a desired shape that defines a volume therein. One or more walls of consistent thickness are formed directly on the packaging support from an amount of an edible shell-forming composition. The composition includes one or more fats, and has a plastic viscosity of about 10 to 40 Poise and a yield value of about 50 to 250 dynes/cm² prior to forming the shell on the support. The walls of the edible fat-based shell preferably have the shape of a cup, cone, or other open top receptacle and a filling is at least partially retained within therein. Prior to consuming the product, the packaging support is removed. The invention also relates to a method and apparatus that includes a specially designed nozzle for producing the edible fat-based shell.

### FIELD OF INVENTION

The present invention relates to an edible fat-based shell for use as an edible receptacle for holding various items, such as confectioneries and preferably frozen confectionery novelties. This invention also relates to a method and apparatus for manufacturing such products.

### BACKGROUND OF THE INVENTION

Increasingly, there is a consumer demand for composite products formed from different edible materials in complementary combinations. There are different combinations of chocolate shells that contain a different component therein. In addition to chocolate confectioneries, many frozen confectionery products are known. One desirable combination is ice cream and chocolate. There are, however, significant production and packaging difficulties involved in the integration and packaging of these materials in various shapes and sizes to produce interesting new products in a consistent and cost-effective manner.

The existing methods for coating or lining frozen confectionery products with chocolate or other fat-based coatings include dipping, enrobing, spraying, and forming. As is well known in the art, dipping and enrobing are unsuitable for lining the interior of cones and other edible and non-edible forms. Traditionally, ice cream cones were lined with a fat-based coating by spraying them with an atomized mist of fat-based coating (known as the “hollow-cone spray” technique) or with one or more jets of non-atomized coating. To achieve acceptable coverage, however, the fat content of such coating needs to be greater than 40% and is typically 50% or greater. Most real chocolates cannot be used for this process because their fat content is too low and their viscosity too high to properly atomize. Thus, high-fat compound coatings are used in this process, and the high fat content of the coating results in diminished taste quality. The high fat content also causes rapid rundown and results in inconsistent cone thickness, with the walls being thinnest at the top rim of the cone and thickening towards the bottom of the cone, producing a large nugget of chocolate at the tip of the cone.

More recently, the frozen cone (also known as “forming”) technology has been used to mold fat-based coating shells inside empty cone sleeves. The frozen cone method consists of a chilled female cone form and a chilled male cone die. Molten chocolate is poured into the female cone form, the male cone die is pressed into the pool of liquid chocolate, and the chocolate hardens into a hollow cone. One of the disadvantages of this technique is that only a few recipes using real chocolate, i.e., chocolate made out of cocoa butter, can be used, because of the process necessitates many operational restrictions. Further, the technique can only be used to line a tapered shape, such as a cone shape.

A variation of these techniques involves pouring or spraying molten chocolate into a female mold, and then pouring off the excess such that the residual material hardens around the inner surface of the mold and can be removed as a self-supporting chocolate shell. One of the disadvantages of this technique, however, is its difficulty in regulating precisely how much material adheres to the mold and, hence, the amount of excess material that will be poured off. Thus, it is difficult to predict the rate at which the chocolate will be consumed in the production process as well as the wall thickness and the mass of the finished product. A further problem is that the method often gives rise to a non-uniform wall thickness in the product, due to the pooling of molten chocolate towards the lowermost part of the mold.

GB 1,017,480 discloses a method for spraying a chocolate coating material on the interior surface of a cone or a receptacle using a nozzle with spraying holes. In this method, the nozzle includes a number of spaced holes for spraying the chocolate against the entire inner surface of a cone or a receptacle. One disadvantage of this technique is the inconsistent thickness of the cone that is produced. If a relatively thick cone is desired, the coating material sprayed at the upper part of the cone will inevitably drip down towards the bottom due to gravity, with the resultant cone having a thickness that increases towards the bottom, with the top rim being the thinnest. This dripping causes the tip of the cone to fill with a large nugget of chocolate. For this reason, the cones that are successfully produced are relatively thin to avoid this pooling of chocolate in the tip of the cone.

What is needed is a method for producing a shell of uniform thickness from any of a wide variety of materials that can be formed into an edible receptacle for use in supporting or carrying other edible items or components. The present invention addresses these problems of the prior art by providing a novel technique that can handle various low-fat and high-fat coating materials and produce products of any shape with consistent thickness.

### SUMMARY OF THE INVENTION

The present invention relates to an edible fat-based shell comprising a packaging support having a desired shape that defines a volume therein; and one or more walls of consistent thickness that are formed directly on the packaging support from an amount of an edible shell-forming composition comprising one or more fats, wherein the composition has a plastic viscosity of about 10 to 40 Poise and a yield value of about 50 to 250 dynes/cm² prior to forming the shell on the support. The walls of the edible fat-based shell preferably have the shape of a cup, cone, or other open top receptacle and a filling is at least partially retained within therein. Prior to consuming the product, the packaging support is removed.

The invention also relates to a method for producing an edible fat-based shell, which comprises preparing a packaging support in a desired shape that defines a volume therein; and directly showering or pouring an amount of an edible shell-forming composition on the packaging support, which composition solidifies to form a shell of consistent thickness thereon, with the composition comprising one or more fats and having a plastic viscosity of about 10 to 40 Poise and a yield value of about 50 to 250 dynes/cm² during the showering or pouring. The shell is formed from an amount of shell-forming composition that is equivalent to what is required for formation of the shell, thus rendering the method highly efficient for producing such shells. Advantageously, the composition is showered from a plurality of streams onto the packaging support.

The invention also relates to an apparatus for producing an edible fat-based shell, comprising a packaging support in a desired shape that defines a volume therein; a nozzle having multiple holes for showering an edible shell-forming composition onto the packaging support wherein the composition solidifies to form a shell, with the composition comprising one or more fats, wherein the composition has a plastic viscosity of about 10 to 40 Poise and a yield value of about 50 to 250 dynes/cm² during showering; and a positioning device for arranging the nozzle and packaging support in an operative position for properly showering the composition onto the packaging support.

The holes of the nozzle allow the coating composition to be applied to the inside of the packaging support or sleeve by showering an amount of the shell-forming composition in discrete streams, and the resulting shell may have a unique, crenelated top edge. In a further advantageous embodiment of the invention, the holes are placed in the nozzle such that the shower streams projected from the holes are not perpendicular against the packaging sleeve. Hence, rather than spraying the packaging sleeve perpendicularly at 90 degrees, the nozzle may provide showers at less than 90 degrees against the packaging sleeve, thus covering a wider area that is being showered. For example, the holes in the nozzle may be angled by around 20 to 35 degrees.

### BRIEF DESCRIPTION OF THE DRAWINGS

Preferred embodiments of the invention will now be described, by way of example only, with reference to the accompanying drawings in which:

FIG. 1 is a cross-sectional view of a nozzle projecting the coating composition to form a crenelated cone-shaped shell;

FIGS. 2A-2B are examples of crenelated cones formed by the shower method; and

FIG. 2C is a comparative example of a cone made by a conventional forming method.

### DETAILED DESCRIPTION OF THE PREFERRED EMBODIMENTS

The present invention provides a novel edible fat-based shell that can be filled with a food such as frozen or non-frozen confections. In particular, the present invention relates to producing frozen confectionery products coated with uniformly thick coating that is made of various recipes of coating materials, and provides a useful and cost-effective alternative to the conventional edible receptacle-forming processes.

The novel “shower” or “shower cone” technology of the present invention allows the use of both low-viscosity materials with high fat contents and high-viscosity materials including real chocolate and other low-fat coatings, and therefore can handle various recipes of real chocolate as well as a wide range of different types of compound coating. The chocolate used in the coating composition may be ordinary or real chocolate according to accepted regulations, or it may be a fat-containing confectionery compound material containing sugar, milk-derived components, and fat and solids from vegetable or cocoa sources in differing proportions. The fat-containing material may be a chocolate substitute containing cocoa butter replacements, stearines, coconut oil, palm oil, butter or any mixture thereof, nut pastes such as peanut butter and fat; praline; confectioner's coatings used for covering cakes usually comprising chocolate analogues with cocoa butter replaced by a cheaper non-tempering fat; or “Caramac” sold by Nestle comprising non-cocoa butter fats, sugar and milk. In addition, these coating materials can be applied by a pouring technique with similar results. Showering with a nozzle is preferred for optimum control over the application of the coating material.

By allowing the use of various shell-forming compositions, from high-fat to low-fat, the present shower technology satisfies the consumer demand for composite frozen confectionery products formed from different material and having varied flavors. Further, since the process can be operated at ambient temperatures, the resultant frozen confectionery products may be slightly softer, with more desirable texture and flavor qualities, than those produced by the conventional forming process, as the warmer operating temperature affects the crystallization of the chocolate or other compound coating.

Because the shower technique involves showering an inside surface of a hollow object using a nozzle, it can be used to apply coating on a surface of any shape. When directly applied to protective wrapper or packaging sleeve, production efficiency is improved and damage and contamination of the exposed product prior to wrapping is prevented.

Another important advantage of the shower technology is the reduced capital and operating costs. The present process is more efficient and cost-effective because it can operate at ambient temperatures and does not require chilled equipment. The brine systems and the air-dehumidification equipment, required for the forming process, may also be eliminated. The decreased manufacturing complexity and cost-effectiveness of the present process would allow the production of flavorful and varied frozen confectionery products by those who would not have been able to afford the conventional technology.

In the following description, “low fat” or “lower fat” in a coating material refers to a fat content of 38% or less. The term “compound coating” refers to a coating based on fats other than cocoa butter, including milk fat and vegetable fats such as coconut oil, palm kernel oil, soybean oil, or a blend of such oils. The term “rundown” is used to describe the amount of coating material that runs down to the bottom of the shell before it is set by being filled with ice confectionery.

The present invention is preferably used for producing frozen novelties and confectionery products that are lined with chocolate or compound coatings. The novel showering technology is used to prepare a shell from any of a wide variety of coating materials, including real chocolate or other lower-fat or high-fat compound coatings. By using a nozzle with multiple, angled holes placed around its rim, the coating composition can be showered in discrete streams, and the angle and the size of the nozzle may be adjusted to achieve the desired coating effect. Showering with streams of coating material from the nozzle also results in a unique appearance, such as a cone with a distinctive crenelation at its top rim.

Although a cone-shaped shell is most often described by way of example, it will be appreciated that the invention embraces various shapes of hollow shells, including the shapes of a bowl, a ball, a flower, and an animal. Similarly, while chocolate coating is used as an example, any type of compound coating may be used. Also, when ice cream is mentioned for use as a filling, any other ice or frozen confectionery filling materials, such as sorbet or water ice, may be used. Thus, the skilled artisan has a wide variety of combinations available for creating filled shell confection novelties.

One aspect of the present invention relates to forming a shell with chocolate or compound coating to hold ice cream or other frozen confectionery materials. The shell may be formed inside a packaging sleeve, replacing the traditional wafer cone, or may be formed inside a wafer cone or other edible surfaces. The packaging support may be made of a non-absorptive food grade material such as paper, foil, transparent, translucent or non-transparent plastic, or a laminate thereof. The coating composition may be based on various edible materials, including cocoa butter and vegetable fats. If the shell-forming composition is low in fat, containing 38% or less fat, a better-tasting shell is obtained, and this is desirable for certain final products.

The flexibility of the present shower technique is seen from the range of coating recipes that can be used with the process. Whereas the conventional “forming” process requires a strict control of such factors as the particle size and the amounts of total fat, free milk fat and lecithin, the factors need not be as strictly controlled in the present process, which therefore allows accommodation of more varied recipes.

For example, the total amount of free milk fat is not as important in the shower process as in the conventional methods. In fact, the relative amount of free milk fat does not at all affect the shower process, and it is possible to use a coating made with a fat phase containing 100% milk fat. Thus, the amount of free milk fat used in the coating recipe can distinguish a cone made by the shower process from the one made by the conventional forming process, since a cone containing a high level of free milk fat can only be made by showering.

The amount of total fat is another distinguishing factor. The total fat content includes the fat content of all the components that contain fat, including milk powder, cocoa powder and cocoa liquor, lecithin, and any other ingredients that are 100% oil or fat. Using no more than 38% total fat would produce desirable shell thickness, but 50% by weight or more of the fat may be used if the showering is performed at a slightly lower temperature or the amount of rundown is otherwise controlled. The invention thus enables the use of low-fat coating materials but also allows higher-fat coating materials to be used. The amount of total fat, however, may preferably be limited to 38% to enhance the flavor of the product, as a lower fat content results in better tasting products.

Moreover, in contrast to the forming process, in which only real chocolate made from cocoa butter can be used, the showering process enables the use of coatings made from vegetable fats such as coconut oil, palm kernel oil or soybean oil, or a blend of such oils. The range of possible coating materials that can be used with the present process, from low-fat to high-fat and from cocoa butter to vegetable fat, also evidences a significant improvement over the hollow-cone spray technique, which can only process atomized high-fat coating materials.

The amount of the emulsifier is important for achieving optimum showering of the coating. The emulsifier is used to reduce the viscosity and/or yield value of the composition. Since the emulsifier speeds up rundown, the total amount of the emulsifier should preferably be limited to around 1%. The emulsifier may comprise lecithin, ammonium phosphatide, polyglyceryl polyricinoleate, or citric acid ester of mono-glycerides, and is preferably added to the coating composition before it passes through the nozzle. One or more emulsifiers can be used in a preferred amount of about 0.05 to 0.65% by weight of the composition.

The composition may also comprise a natural or artificial sweetener. For example, sugar or dried honey, corn syrup solids, lactose, or anhydrous dextrose may be used for the sweetener, or an artificial sweetener such as malitol, xylitol, lactitol, mannitol, or polydextrose may be used. The sweetener also may be a high-intensity sweetener such as acesulfame K, sucralose, or aspartame. When used, the sweetener is present in the composition in an amount of about 25 to 60% by weight. Examples 1 and 2 provide further illustration of preferred compositions by providing two recipes that can be used to make shower cones.

The shower method is adapted for continuous multiple operation, and can be applied in a production line. The line is indexed, and includes a number of stations and an automated conveyer that transports packaging sleeves. The line pauses at each station before proceeding to the next. Initially, packaging sleeves move past a station where the nozzle showers molten chocolate or other compound coating material into the sleeve. The line then proceeds to another station where the shell is filled with a filling.

In one preferred embodiment, a chocolate volumetric dosing device that includes a nozzle delivers chocolate coating material at the desired production output. This device may include a lifting station for moving nozzles or packaging sleeves.

The production line may be assembled such that either the nozzle or the shell packaging sleeve moves along the production line. In one example, the nozzle is stationary and the sleeve moves to the nozzle to be showered. In another example, the sleeve is stationary and the nozzle moves down to the sleeve to shower at a desired height for the desired shell size. Ice cream cone production lines generally have lift stations such that the nozzle can move down into the packaging sleeve to pour or shower the chocolate. With the present technique, such lift stations may be used if equipment is available, or, alternatively, a sleeve lift station for lifting the sleeve to the nozzle may be used.

The shower nozzle in the device can be easily modified to adapt to different types of shell-forming equipment. Further, the equipment may be set for a nozzle having holes at a specific angle, so that the same nozzle can be used without requiring height or setting adjustments.

In a further embodiment of the invention, the coating composition does not flow from the shower nozzle in a continuous stream, but the amount of the composition being showered through the nozzle is metered so as to prevent dripping of the composition from the nozzle between successive shower applications. A volumetric coating metering device may be used, and a short “suck-back” step may be incorporated at the end of each showering to further prevent any small drips. This enables the nozzle to be operated to dispense an amount of shell forming composition that is precisely equivalent to what is required for formation of the shell. As no excess coating material is dispensed, the wall thickness of the shell is provided with a controlled thickness. This means that wall thickness at the bottom of the one is not more than 200% of that at the top of the cone and is at least 1 mm to about 6 mm at the top of the cone.

A mini cone of about 30 ml can be made with one nozzle depositing about 7 to 15 grams of the coating composition at a time, while a larger cone of about 120 ml may be made by two successive showers with two depositors. For example, where each depositor showers about 7 to 15 grams of the coating composition, a larger shell of about 14 to 22 grams can be made by the double shower process, in which two successive showers are applied.

The invention provides a coating composition that has preferred flow properties for being dispensed by the nozzle in a showering or pouring mode. Achieving the right flow properties, such as plastic viscosity and yield value, at the application temperature is important for properly forming a shell, because the coating composition is projected onto the uppermost part of the packaging sleeve during the shower process and must drip downward to form a shell. If the composition is too thick and too viscous, there will be insufficient rundown and uneven coating coverage, and may even result in windows or tears on the shell. A composition that is too thin, on the other hand, will lead to too much rundown and thin, crumbling walls. A composition with the right degree of viscosity will run evenly down the walls of the wrapper before it is filled with a frozen confection.

For optimum flow properties, the shell-forming composition should have a plastic viscosity of about 10-40 Poise (1-4 Pascal seconds) and a yield value of about 50-250 dynes per square centimeter (5-25 Pascals) at the temperature the composition is showered. Such flow properties will allow the coating composition to drip downward at a desirable speed after being showered onto the packaging sleeve, such that a uniformly thick shell in the desired shape is formed. Viscosity and yield values can be calculated from multiple torque readings taken with a Brookfield RV viscometer with SC4-28 spindle, using the modified Casson equation for chocolate viscometry.

Since the coating composition is showered through the holes in the shower nozzle, the composition particle size should be small enough to pass through the holes. Blockage or clogging of the hole may occur if the coating composition contains a particle larger than the hole diameter. Clogging may also be caused when a significant number of particles are larger than one third of the diameter of the hole, because the particles may bridge together to cause blockage. Filtering the coating composition prior to showering will prevent such clogging. When the showering process is stopped, removing and cleaning the nozzle will also help prevent clogging of the holes.

In a preferred example of the invention, the particle size of the composition is about 50 microns or less for a nozzle hole with a diameter of about 1 mm. Small particle sizes are also preferred because larger particle sizes may increase rundown and cause the shell to taste coarse.

To further prevent clogging the nozzle holes, the coating composition should preferably be showered above the melting point of its principal fats (the “set point” of the composition). If the composition is allowed to fall below the set point of the composition, lumps of solid coating may form and block the nozzle holes. The coating composition should therefore preferably be showered and maintained at a temperature higher than its set point in order to prevent such blockage. For example, the shower process is preferably conducted at around 42° C. to 48° C., and more preferably at around 45° C., for a coating composition made of real milk chocolate. If fats with lower melting points are used, the showering temperature can also be adjusted appropriately. In another example, showering can be done at about 32 to 38° C., and more preferably at about 35° C., when the composition's principal fats include coconut oil. However, unlike the conventional forming process which requires very strict temperature restrictions, the exact processing temperature is not as critical as long as it is maintained above the set point of the composition.

One inventive feature of the present invention is its use of shower nozzles with orifices or holes placed around the rim of the nozzle. As the holes are placed along the rim of the nozzle and not at its center, the composition, when projected against a surface, will form a band on the surface corresponding to the rim of the nozzle. Thereafter, the showered composition will flow down and towards the center and converge, such that a closed shell is formed. During this process, providing the composition with proper flow properties is critical for forming a shell with desired and uniform thickness.

In one embodiment, the nozzle is set up at a diameter of 0.65 inches and with twenty to twenty-four holes. For such nozzle, the holes may preferably be about 0.04 inches in diameter. The diameter of the hole may be increased without changing the composition's flow properties so that any nozzle blockage is eliminated. In another preferred embodiment, a larger nozzle, with around 48 holes, can be used to make a large cone having a capacity of about 120 ml. Using a larger nozzle will result in a more even appearance at the top of the cone.

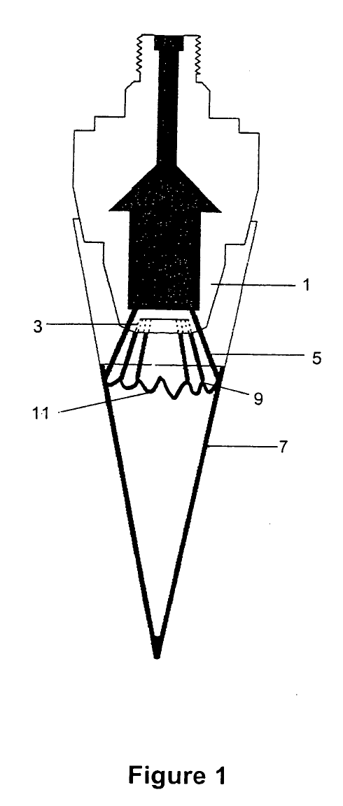

Another benefit of using a nozzle with multiple holes or orifices is that the resulting shell has a very distinctive and unique appearance. As shown in FIG. 1, when the chocolate coating material is projected in discrete streams 5 from the holes 3 of a nozzle 1 and deposited on the interior walls of a packaging sleeve or a form, the chocolate material solidifies as it gradually accumulates under each hole, thus forming a mound under each hole. The result is a non-uniform top rim, with a distinctive pattern that can be characterized as “crenelation.” For example, referring again to FIG. 1, when a shower nozzle with twenty-four holes 3 is used, the chocolate accumulates under each of the twenty-four holes 3, and the produced cone 7 has twenty-four “peaks and valleys” at the top rim, with each peak 9 being the chocolate accumulating under the hole 3 and each valley 11 being the area between two adjacent holes, where the chocolate streams merge.

In a preferred embodiment, the invention relates to a composite frozen confectionery item that comprises a packaging support, a shell and a filling that is at least partially supported by the shell. The shell has a consistent thickness and is formed directly on the support from an edible shell-forming composition that comprises a fat, an emulsifier, and a sweetener. The shell-forming composition advantageously has a plastic viscosity of about 10 to 40 Poise and a yield value of about 50 to 250 dynes/cm² to obtain desirable preferred flow properties. The shell preferably has the shape of a cone, and the top rim of the cone may be crenelated to provide a visually distinctive pattern.

The filling, which may be any confection but preferably comprises an ice confection such as ice cream, sherbet, or water ice, may partially fill, completely fill or even overfill the shell. For the latter, a mass is exposed outside of the shell. Preferably, the filling may extend beyond cone rim and be exposed on top of the cone for easy consumption.

In another preferred embodiment of the invention, the shell may include on its inner surface edible inclusions, such as ground nuts, cookie crumbs, cereal, fruit pieces, chocolate chips, candy pieces or coconut.

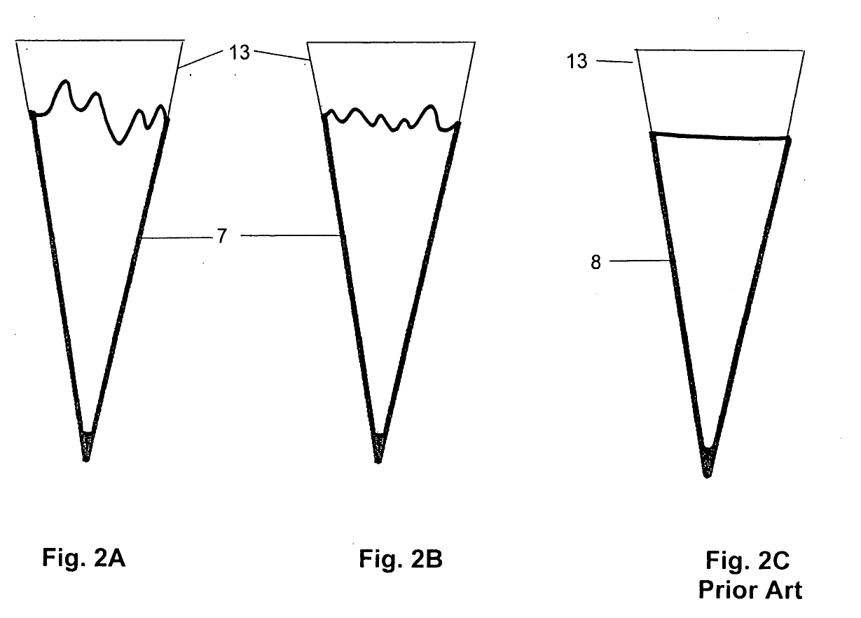

Both conventional rim and crenelated cones can be formed according to the present invention by the appropriate alignment of the nozzle holes. FIGS. 2A and 2B provide further illustration of such crenelated cones 7, filled with an ice confection 13, made by the shower process. A cone 8 made by the forming process is shown in FIG. 2C for comparison.

In a further advantageous embodiment, the holes may be angled at different degrees to achieve different showering effects. A nozzle may have holes facing straight down such that the coating composition is showered at 90 degrees against the packaging sleeve, or the holes may be placed such that the coating composition is showered at less than 90 degrees against the packaging sleeve. As each hole projects a predetermined amount of molten coating composition onto the packaging sleeve, a nozzle with holes facing 27 degrees up from the downward (90-degree) position would achieve a wider shower coverage, while a nozzle with holes removed from the downward position by 22 degrees would provide a relatively more concentrated coverage of a narrower area. In most cases, the nozzle includes no holes that direct the coating composition directly into the tip or lower portions of the cone, since this could lead to the formation of a pool of coating material in the tip which eventually forms a plug therein.

In one preferred embodiment, a 27-degree nozzle, i.e., a nozzle whose holes are angled at 27 degrees from the 90-degree position, with twenty-four holes is used to make a mini cone of about 30 ml, having a height of about 100 mm and a diameter of about 35 mm at the top rim. A mini cone made with the 27-degree nozzle will have a distinctive “crenelation” of a crown shape at its top edge. A 27-degree nozzle or a 22-degree nozzle can also be used to make a larger cone of about 120 ml with a height of about 170 mm. The crenelation at the top rim of a larger cone may be more pronounced, with each cone having its own unique pattern.

The nozzle angle can be changed to accomplish complete and uniform coating of the desired size cones. This effect may also be accomplished by adjusting the lift station to lift and properly position the cone sleeve. Changing the angle of the nozzle hole for the particular product results in less manufacturing downtime. The showering of the coating material near the top of the cone enables the coating material to form the cone by flowing down the sleeve or mold into which the coating is showered.

In addition to adjusting the showering angle, the showering pressure may also be adjusted to achieve the desired shower effect. In one embodiment, a pressure of about 1-2 bar may be applied on the depositor making mini cones of about 30 ml.

The shower process may be repeated such that the packaging sleeve is showered two or more times with the same or different amount of the coating material. By adjusting the nozzle angles and showering height, such multiple shower processes are used to produce larger shells. It will also be appreciated that additional layers of the shell may be built up sequentially by repeating the showering steps. The subsequent layers may be formed from the same coating material, or from a different coating material.

The present invention also provides for adding particulate inclusions such as ground nuts or candy pieces into chocolate or compound cones or shells in a conventional way. Although particulate inclusions should not be added during the showering process itself because the particulate may block the small holes in the shower nozzle, they can be added afterwards to the inside wall of the shell. As the following Examples 6 and 7 explain, a number of different particulate materials may be introduced into the chocolate or compound cone, including ground nuts, cereals, cookie fines, pieces of candy, chocolate or compound chips or chunks, fruit pieces, and coconut.

The end result of the present invention is a confectionery product comprising a shell filled with a confectionery filling. Suitable decorative or complementary toppings may be introduced, and the shell may further include particulate inclusions that are embedded after the showering process. By utilizing the flow properties of the coating composition and the novel shower nozzle, the present method achieves uniform coating coverage of the shell with desired thickness and provides a unique way of producing shells of various shapes that can be filled with confection or frozen confectionery materials. Furthermore, a wider range of coating materials may be incorporated in the present shower method than was possible with the conventional methods, and a shell produced by the shower technique, a cone in particular, will have a distinctive appearance that is appealing to the consumer.

Manufacturers will also appreciate that the present shower technology, which can be conducted at ambient temperatures and eliminates the requirements for chilled or air-dehumidification equipment, is less complex and simpler to operate than the conventional forming process. In this sense, the shower process is more practical than the conventional shell-making processes, as it reduces capital and operational costs. Specifically, when real chocolate is used to form the shell, it will solidify upon cooling to room temperature without requiring refrigeration or the lower temperatures of an ice confection to solidify the shell. These features also enable the shell to be used for other confections, such as marshmallow, fudge, jelly, peanut butter, other chocolate compositions or other confectionery components. Thus, any of a wide range of fillings are suitable for use in this invention although ice confections are preferred.

### EXAMPLES

The following examples further illustrate some of the preferred embodiments of the present application. It should be noted that, although described with reference to specific examples, the invention will be appreciated by those skilled in the art in many other forms and embodiments.

### Example 1

Shower cone recipe for real milk chocolate-based coating (% by weight)

| | |
|---|---|
| Sugar | 44.3 |
| Cocoa liquor | 15 |
| Cocoa butter | 19.5 |
| Whole milk powder | 20 |
| Anhydrous butterfat | 1 |
| Vanillin | 0.05 |
| Lecithin | 0.15 |

### Example 2

Shower cone recipe for vegetable fat-based coating (% by weight)

| | |
|---|---|
| Sugar | 44.5 |
| Cocoa powder | 9 |
| Coconut oil | 28.3 |
| Whole milk powder | 18 |
| Vanillin | 0.05 |
| Lecithin | 0.15 |

### Example 3

### Milk Chocolate Cone Made by Showering

A radially symmetric shower nozzle consisting of twenty-four holes was used to deliver exactly 6 grams of real chocolate at 33% by weight of fat into an empty 110 mm cone sleeve. The formed milk chocolate cone was then filled with vanilla ice cream and frozen. The end consumer of this product removes the sleeve to reveal a milk chocolate cone novelty filled with ice cream.

Coating recipe (% by weight): sugar 52.1, whole milk powder 12, cocoa liquor 13, cocoa butter 21.4, anhydrous butterfat 1, soy lecithin 0.3, vanilla 0.2.

Total fat content: 33% by weight Particle size: 24-26 microns

### Example 4

### Wafer Cone Lined with Real Milk Chocolate Made by Showering

In a manner similar to that of Example 3, real milk chocolate may be showered into a sugar wafer cone. The cone is then filled with ice cream and frozen. Real milk chocolate with only 33% fat will have a unique flavor and texture compared to the high-fat coatings normally used to line ice cream cones.

### Example 5

### Compound Pig Made by Showering

15 grams of pink colored compound with 32% by weight of fat is shower showered into a small empty plastic pig. The pig is then filled with pink marshmallow-flavored sherbet and frozen. Optionally, the open top of the pig may be topped with 1 or 2 grams of pink coatings to seal in the sherbet. The consumer removes the outer plastic cover to reveal a pink pig filled with sherbet.

Coating recipe (% by weight): sugar 58.5, non-fat dry milk 6, whey powder 3, coconut oil 31.7, soy lecithin 0.2, PGPR emulsifier 0.1, titanium dioxide 0.1, red 40 lake 0.1, flavor 0.3.

Total fat content: 32% by weight

Particle size: 28-30 microns

### Example 6

### Milk Chocolate Shower Cone Containing Small Pieces of Chopped Almonds

A mini cone is made by showering 7 grams of real milk chocolate with 34% by weight of fat into a mini cone sleeve using a nozzle with twenty-four 1-mm diameter holes. 0.8 grams of finely chopped almonds are placed on the particulate applicator. The applicator is then lowered into the cone and spun rapidly at around 100-200 rpm, forcing the inclusions to fly off the applicator into the walls of the cone.

After the particulate application, the cone contains approximately 10% by weight of almonds. The applicator is withdrawn and the cone is filled with 14 grams of ice cream. The top of the ice cream cone may be decorated with more ice cream and/or sauce and/or sprinkles. It may be sprinkled with more particulates such as almonds or chocolate chips.

The incorporation of the particulate inclusions adds further complexity to the flavor of the cone product and imparts crunchy texture.

### Example 7

### White Chocolate Shower Cone Containing Chocolate Cookie Fines

An ice cream cone is made according to the method described in Example (above), but the cone is made with white chocolate containing 35% by weight of fat and the particulate inclusions are chocolate cookie fines. The consumer experiences a more varied flavor and crunchy texture when eating the ice cream cone.

1. An edible fat-based shell comprising:
a packaging support having a desired shape that defines a volume therein; and
one or more walls of consistent thickness that are formed directly on the packaging support from an amount of an edible shell-forming composition comprising one or more fats, wherein the composition has a plastic viscosity of about 10 to 40 Poise and a yield value of about 50 to 250 dynes/cm² prior to forming the shell on the support.

2. The edible fat-based shell of claim 1 having the walls have the shape of a cup, cone, or other open top receptacle and which further comprises a filling that is at least partially retained within the shell.

3. The edible fat-based shell of claim 2, wherein the filling is a confectionery that completely fills the shell.

4. The edible fat-based shell of claim 2, wherein the filling comprises an ice confection.

5. The edible fat-based shell of claim 4, wherein the ice confection comprises ice cream, sherbet, or water ice and is present in an amount that extends beyond the open top of the receptacle so as to be provided as an exposed mass for easy consumption.

6. The edible fat-based shell of claim 1, wherein the composition further comprises an emulsifier in an amount of no more than 1% by weight of the composition and a sweetener.

7. The edible fat-based shell of claim 6, wherein the emulsifier comprises lecithin, ammonium phosphatide, polyglyceryl polyricinoleate, citric acid ester of mono-glycerides or combinations thereof.

8. The edible fat-based shell of claim 6, wherein the sweetener comprises sugar, dried honey, corn syrup solids, lactose, anhydrous dextrose, malitol, xylitol, lactitol, mannitol, polydextrose, acesulfame K, sucralose, aspartame, or combinations thereof.

9. The edible fat-based shell of claim 6, wherein the edible shell-forming composition includes the fat in an amount of between about 15 and 38% by weight, the emulsifier in an amount of about 0.05 to 0.65% by weight, and the sweetener in an amount of about 25 to 60% by weight.

10. The edible fat-based shell of claim 1, wherein the shell has the shape of a cone.

11. The edible fat-based shell of claim 10, wherein the cone has a crenelated top rim.

12. The edible fat-based shell of claim 1, wherein the shell includes inclusions on an inner surface.

13. The edible fat-based shell of claim 12, wherein the inclusions comprise nuts, cookie crumbs, cereal, fruit pieces, chocolate chips, candy pieces or coconut.

14. The confectionery item of claim 1, wherein the packaging support is a non-absorptive food grade material comprising paper, foil, transparent, translucent or non-transparent plastic, or a laminate thereof.

15. A method for producing an edible fat-based shell, which comprises:
preparing a packaging support in a desired shape that defines a volume therein; and
directly showering or pouring an amount of an edible shell-forming composition on the packaging support, which composition solidifies to form a shell of consistent thickness thereon, with the composition comprising one or more fats and having a plastic viscosity of about 10 to 40 Poise and a yield value of about 50 to 250 dynes/cm² during the showering or pouring.

16. The method according to claim 15, wherein the shell is formed from an amount of shell-forming composition that is equivalent to what is required for formation of the shell.

17. The method of claim 15 wherein the walls have the shape of a cup, cone, or other open top receptacle and which further comprises providing a filling that is at least partially retained within the shell.

18. The method of claim 17, wherein the filling is a confectionery that completely fills the shell.

19. The method of claim 18, wherein the filling comprises an ice confection.

20. The method of claim 19, wherein the ice confection comprises ice cream, sherbet, or water ice and is present in an amount that extends beyond the open top of the receptacle so as to be provided as an exposed mass for easy consumption.

21. The method of claim 15, wherein the composition further comprises an emulsifier in an amount of no more than 1% by weight of the composition and a sweetener.

22. The method of claim 21, wherein the emulsifier comprises lecithin, ammonium phosphatide, polyglyceryl polyricinoleate, or citric acid ester of mono-glycerides.

22. The method of claim 21, wherein the sweetener comprises sugar, dried honey, corn syrup solids, lactose, anhydrous dextrose, malitol, xylitol, lactitol, mannitol, polydextrose, acesulfame K, sucralose, or aspartame.

24. The method of claim 15, wherein the packaging support and shell are each formed as a cone.

25. The method of claim 24, wherein the shell is formed with a crenelated top rim.

26. The method of claim 24, which further comprises providing inclusions on an inner surface of the shell prior to providing the filling therein.

27. The method of claim 15, wherein the packaging sleeve is a non-absorptive food grade material comprising paper, foil, transparent, translucent or non-transparent plastic, or a laminate thereof.

28. The method of claim 15, wherein the composition is showered from a plurality of streams onto the packaging support.

29. An apparatus for producing an edible fat-based shell, comprising:
a packaging support in a desired shape that defines a volume therein;
a nozzle having multiple holes for showering an edible shell-forming composition onto the packaging support wherein the composition solidifies to form a shell, with the composition comprising one or more fats, wherein the composition has a plastic viscosity of about 10 to 40 Poise and a yield value of about 50 to 250 dynes/cm² during showering; and
a positioning device for arranging the nozzle and packaging support in an operative position for properly showering the composition onto the packaging support.

30. The apparatus of claim 29, wherein the nozzle is operated to dispense an amount of shell-forming composition that is equivalent to what is required for formation of the shell.

31. The apparatus of claim 29, wherein the packaging support has the shape of a cup, cone, or other open top receptacle and the shell conforms to the shape of the support.

32. The apparatus of claim 29, wherein the holes are placed in the nozzle to provide streams that are angled at less than 90 degrees against the packaging sleeve.

33. The apparatus of claim 29, wherein the holes in the nozzle are angled by about 20 to 35 degrees.
